(19) United States
(12) Patent Application Publication
(10) Pub. No.: US 2021/0179298 A1
(43) Pub. Date: Jun. 17, 2021

(54) SYSTEM AND METHOD FOR DETERMINING AN INITIAL ORBIT OF SATELLITES POST DEPLOYMENT

(71) Applicant: VisSidus Technologies, Inc., Kihei, HI (US)

(72) Inventor: Bogdan Udrea, Kihei, HI (US)

(21) Appl. No.: 17/116,725

(22) Filed: Dec. 9, 2020

Related U.S. Application Data
(60) Provisional application No. 62/946,497, filed on Dec. 11, 2019.
(60) Provisional application No. 62/947,029, filed on Dec. 12, 2019.

(51) Int. Cl. B64G 1/36; B64G 3/00; B64G 1/24

(52) U.S. Cl. CPC B64G 1/365; B64G 1/007; B64G 1/242; B64G 3/00

(57) ABSTRACT

A system for determining an initial orbit of an object launched from an orbiting launch vehicle has a sensor affixed to the launch vehicle. The sensor transmits electromagnetic signals toward the launched object launched and receives signals reflected therefrom as reflected signals. A navigation subsystem determines a relative position of the sensor to the earth. A command and data handling subsystem receives the reflected signals and the determined relative position to the earth and determines a position of the object launched from the launch vehicle relative to earth.

### CROSS REFERENCE TO RELATED APPLICATION

This application claims priority to US Provisional Application No. 62/946,497 filed Dec. 11, 2019, and US Provisional Application No. 62/947,029 filed Dec. 12, 2019, the contents of each of which are herein incorporated.

### BACKGROUND OF THE INVENTION

The present invention is directed to a system and method for tracking objects launched from a platform, and more particularly, to determine and establish the initial orbit of satellites deployed from a platform travelling through outer space soon after deployment; i.e., soon after the moment of release from the platform, within seconds after deployment; the time it takes to travel the 0.5 to 20 meters to be within the sensor range.

Ever since humanity entered the space-age in the late 1950s it has been launching satellites and other objects into space to then be maintained in orbit about the earth. In the early days, and most of today's launches, single rockets launched a relatively small number of objects, typically one object per rocket. Therefore they have been easily tracked by earth-based radar and optical systems. Satellite operators typically need a few passes of one satellite through the field of view of the earth-based radar and optical systems, taking hours to days, to determine orbital parameters of their satellite.

However, in the past decade the advent of small satellites led to the launch of tens to more than a hundred satellites by a single rocket. A notable example is the Indian Space Research Organization (ISRO) Polar Satellite Launch Vehicle (PSLV) flight C37 2017 launch of 104 satellites. The satellite Cartosat-2D, 712 kg and the size of a small car, was C37's primary payload and the other one hundred and three secondary payload satellites were small satellites, of the nanosatellite class, with sizes as small as a loaf of bread and mass of 4 kg. As a result, the prior art earth-based sensors tasked with observing satellites after release, so that their orbital parameters can be determined, are overwhelmed. Consequently, the uncertainties of the initial orbit parameters and epoch of these orbits can be large and make the initial orbit determination problematic and resource intensive. By orbit parameters it is meant either the three-dimensional position vector and three-dimensional velocity vector or six orbital elements such as semi-major axis, eccentricity, inclination, argument of periapsis, right ascension of the ascending node, and true anomaly This uncertainty can lead to extensive use of ground based sensors to search for the satellites and establish orbital parameters. This is further exacerbated by the plans for a few low earth orbit communications networks which contemplate the launching of hundreds if not thousands of small satellites substantially simultaneously at a rapid cadence; as a result of substantially simultaneous launch from a single vehicle.

As seen in FIGS. 1A, 1B a launch vehicle 12 has an upper stage, platform, 12a carrying a payload P of P₁-P_{N} satellites to be launched therefrom. As seen in FIG. 1A, launch vehicle 12 launches from earth 10 and during ascent to orbit OR it exposes its payload P for launch as known in the art. As seen in FIG. 1B, each payload establishes a respective orbit O₁-O_{N} upon deployment from launch vehicle launch platform 12a. It is desirable to determine the orbit parameters of each launched satellite P_{N} relative to the earth 10 as quickly as possible so that satellite operators have a timely and accurate set of orbit parameters for each satellite and catalogs that contains orbit parameters can be updated rapidly and accurately.

The problem becomes that as the number of launch satellites increases, as they establish orbits, earth-based initial orbit determination becomes difficult, inaccurate, and sometimes impossible utilizing the ground based prior art systems. Ground based active sensors such as radars and laser rangefinders get overwhelmed as too many objects appear as “chaff,” and the multiple inputs saturate and confuse the sensors. Additionally, prior art passive optical sensors, such as telescopes, have too narrow a field of view to capture the large number of satellites being launched. They require several passes of each satellite to accurately make observations required to perform initial orbit determination. Both senor types quickly get overwhelmed when dealing with the number of satellites now contemplated to be launched.

Accordingly, it is desired to provide an initial orbit determination system which overcomes the shortcomings of the prior art and enables more timely and accurate tracking of multiple payloads immediately after deployment from the platform (rocket).

### SUMMARY OF THE INVENTION

A system for determining an initial orbit of an object launched from an orbiting launch vehicle includes a sensor affixed to the launch vehicle. A command and data handling subsystem that includes a computer and one or more digital and analog interfaces receiving inputs from the sensor. A navigation subsystem, connected to the command and data handling subsystem determines the orbital parameters of the launch vehicle relative to earth, the orientation and angular rates of the launch vehicle with respect to a celestial reference frame, and transmits them to the command and data handling subsystem. A communications subsystem is also connected with the command and data handling subsystem and it is used to transmit and receive messages between the command and data handling subsystem and an earth-based communication system of a ground station. The sensor is an active device for transmitting electromagnetic signals toward the object launched from the launch vehicle, and receiving the signals reflected therefrom by the object that was launched.

The command and data handling subsystem processes the reflected signals of the sensor and determines the range, azimuth, and elevation angles of the launched object. The command and data handling subsystem determines the position and velocity vectors of a launched object relative to the platform. The command and data handling subsystem further receives the output of the navigation subsystem and combines the relative position and velocity vectors with the orientation and orbital parameters of the platform and determines the orbital parameters of the launched object with respect to earth. Finally, the orbital parameters, that represent the initial orbit of the launched object relative to earth, are transmitted to a ground station by the communication subsystem of the invention.

In one embodiment of the invention the transceiver is a phased array device and more particularly, a radar sensor. In another embodiment the sensor is a flash lidar. The navigation subsystem and command and data handling subsystem may be integrally formed with the launch vehicle. In effect the launch vehicle is a platform

In another embodiment of the invention the system includes a discrete platform. The platform is mounted on the launch vehicle. The sensor, navigation determination subsystem, and command and data and subsystem are disposed on the platform. The sensor has a wide field of view and a close range.

Because the platform, and hence the sensor affixed to it, can rotate after the object is launched the invention can include as many sensors as needed to obtain a cumulative field of view extending up to a full sphere (4π steradian) with a range out to about 1 kilometer.

In yet another embodiment of the invention the launch vehicle rotates relative to the launched payload. When the cumulative sensor field of view is less than a full sphere, the reflected signal is received periodically.

### BRIEF DESCRIPTION OF THE DRAWINGS

The present disclosure will be better understood by reading the written description with reference to the accompanying drawings, in which like reference numerals denote similar structure and refer to like elements throughout in which:

FIGS. 1A, 1B are schematic drawings showing a launch vehicle for launching a multiple satellite payload into orbit as known in the art;

FIG. 2 is a schematic diagram of the system for determining initial orbit of a satellite constructed in accordance with one embodiment of the invention; as deployed on a launch vehicle;

FIG. 3 is a block diagram of a system for determining the initial orbit of the satellite constructed in accordance with the invention;

FIG. 4 is a plot of the field of view of one embodiment of the sensor operating in accordance with the invention, the thin lined portions of the path being the path of the launched object with respect to the sensor that rotates with the launch platform, and the thicker lined portions of the path being the path of the launched object in the field of view of the sensors, thus illustrating timing of the sensed object within the field of view of a sensor constructed in accordance with the invention;

FIG. 5 is a graph of the detection of the reflected signal by the sensor, as a function of the velocity and distance of the object detected at each instance of detecting the reflected signal within the field of view;

FIG. 6 is a flowchart for tracking the initial orbit of satellites deployed from a platform travelling through outer space in near real-time after deployment ; and

FIG. 7 is a schematic drawing of a system for detecting the initial orbit of a satellite constructed in accordance with another embodiment of the invention.

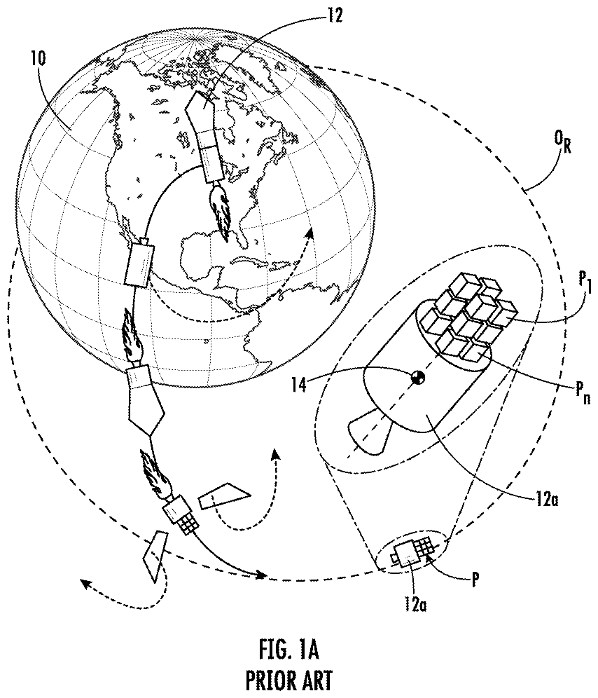

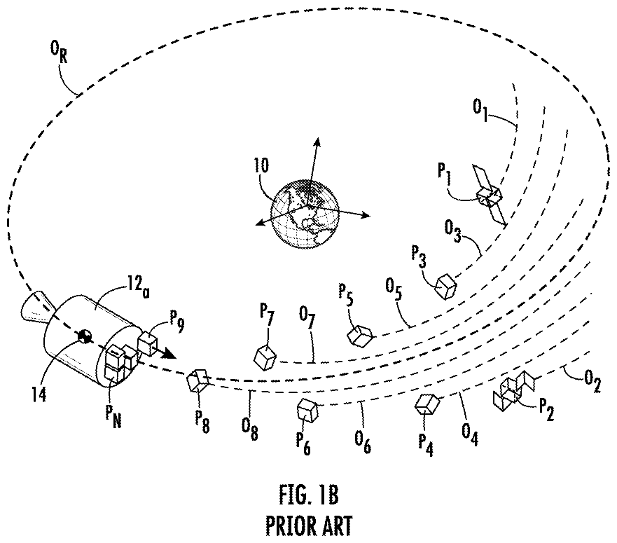

### DETAILED DESCRIPTION OF THE PREFERRED EMBODIMENTS

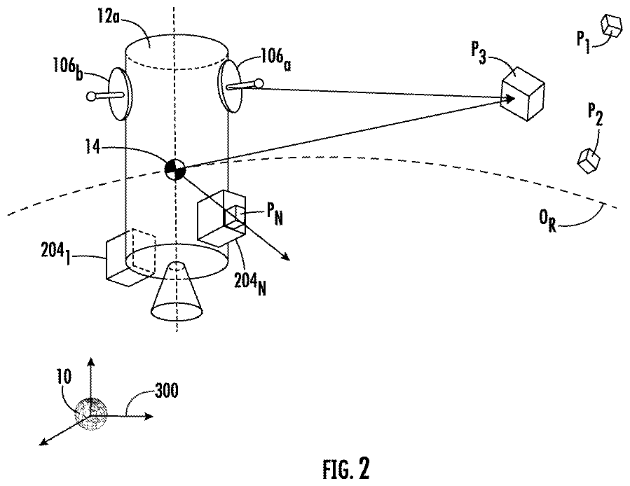

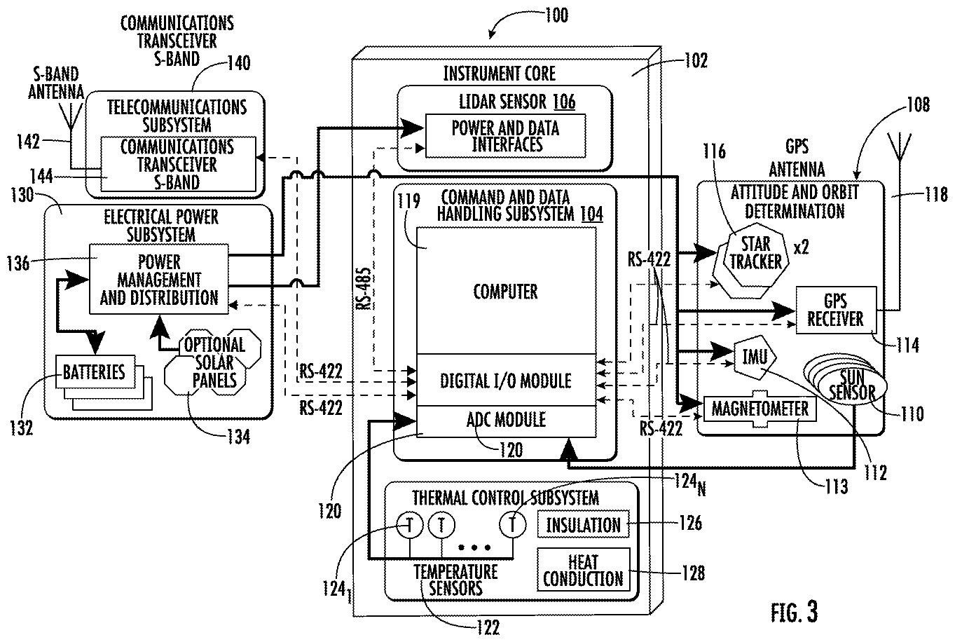

Reference is now made to FIGS. 2 and 3 in which a system 100 for determining initial orbit, constructed in accordance with the invention, disposed on a launch vehicle 12a is shown in detail. System 100 includes a platform 102. Platform 102 may be a substrate mounted to launch vehicle 12a, or may be the structure of launch vehicle 12a itself; in other words, system 100 may be integrated into launch vehicle 12a.

System 100 includes a command and data handling subsystem 104 mounted on platform 102.

The command and data handling subsystem 104 receives and processes information from a sensor 106 and a navigation subsystem 108, each described below, and provides an output to a telecommunications subsystem 140 for reporting results back to earth 10.

As discussed above as known in the art, launch vehicle 12a is provided with one or more satellite deployers 204₁-204_{N}. To simplify matters, for ease of explanation, it is assumed in this description that deployers 204 launch payloads P in a direction substantially orthogonal outward from the surface of launch vehicle 12a upon which the deployers 204 are disposed. Payloads P are launched with a known velocity in the substantially X_{P} direction.

Each respective sensor 106 is mounted on launch vehicle 12a with an orientation facing away from launch vehicle 12a to facilitate monitoring payloads P₁-P_{N} substantially simultaneously as launched. In other words, as a result of field of view size and orientation selection, positioning of sensors 106 relative to deployers 204, deployed satellites enter the field of view of a given sensor 104 substantially immediately upon deployment. Operatively, sensors 106 are active sensors positioned near the deployers 204 to assess the relative orbital path of payloads P with respect to sensor 106. Each sensor 106 emits a signal which is reflected back from each respective payload P within the field of view of the respective sensor 106 to be received by a respective sensor 106 as a reflected signal. Sensors 106 may determine range (distance) and one angle (azimuth) or both angles (azimuth and elevation). As a result, the reflected signal is indicative of position and velocity of the payload P relative to sensor 106. Preferably sensors 106 are oriented so that the signal is emitted from sensor 106 in a direction substantially parallel with the direction of payload launch; in the X_{P} direction. This maximizes the period of time within which a specific payload P_{N} is within the field of view of a respective sensor 106 and the orientation direction of the sensor can be determined prior to launch through simulations.

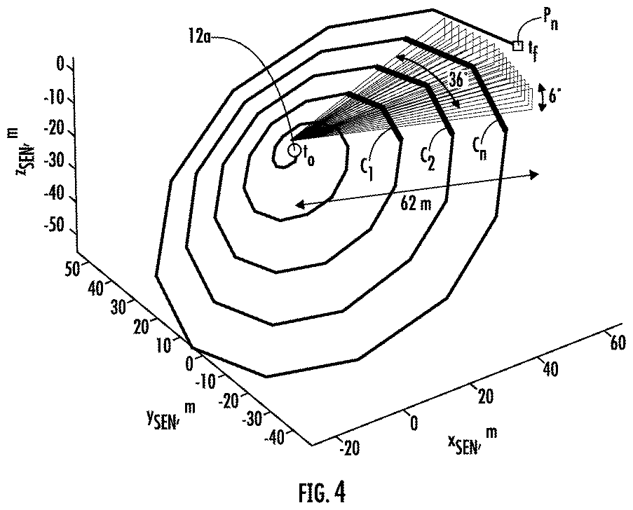

System 100 is primarily concerned with determination and tracking of the initial orbit. Therefore, the field of view of sensor 106 is preferably wide, along an axis Y_{S}, but not necessarily deep along an axis X_{S} as shown in FIG. 4. In preferred non limiting embodiments, the field of view of the sensor is within a range of 6°-160° and preferably 90°.

The range of the sensors is preferably between 20 m to 1000 m from sensor 106, but some contemplated radars and lidars have a range of ranges between 0.05 m up to 200 m. Additionally, launch vehicle 12a rotates about its center of mass 202 during the deployment so that as launch vehicle 12a travels along its orbital path O_{R} during a deployment procedure, a specific payload will appear to travel across the field of view of a single sensor 106 as result of the motion of sensor 106 relative to payload P as payload P finds its orbital path as launch vehicle 12a rotates. Therefore, it is desirable to have at least a second sensor 106_{b} for tracking payloads P. As a specific payload P_{N} leaves a field of view of a first sensor 106ₐ it will come into view of a second sensor 106_{b}. Most preferably the arrangement of sensors includes as many sensors as needed to obtain a cumulative field of view extending up to a full sphere (4 π steradian) with a range out to about 1 kilometer. As a result, there is a longer tracking time and greater tracking field of view and increased length of the reflected signal; increasing accuracy in determining the current position of the satellite, and the initial orbit of any particular payload P.

Sensors 106 emit signals in either the radio or optical frequency range, including visible and near infrared spectra. In a preferred nonlimiting embodiment sensor 106 is a phased array transceiver capable of emitting signals to an object and receiving signals reflected therefrom which are utilized to determine distance and relative position; velocity, azimuth, and elevation. In the preferred non limiting embodiment sensor 106 is a flash lidar sensor, but a radar sensor may be used as well. The received reflected signal is input to the command and data handling subsystem 104 where the distance and velocity of the sensed payload P, relative to sensor 106, and in turn to system 100, is determined as a function of the reflected signal.

However, determining the position of a particular payload during initial orbit relative to launch vehicle 12a is not helpful to determining the orbit relative to earth 10 so that others will know the positioning of the payload P relative to earth and other objects orbiting earth 10. Therefore command and data handling subsystem 104 also determines the position of the center of mass 202 of launch vehicle 12a relative to the frame of reference with the origin at the center of mass 304 of earth 10. To accomplish this, system 100 also includes a navigation subsystem 108 (also “navigator”) for providing orbit parameters information of launch vehicle 12a relative to earth 10 and orientation of launch vehicle 12a with respect to the celestial sphere to the command and data handling subsystem 104.

Navigator 108 includes a plurality of navigation sensors for determining the orbital parameters of launch vehicle 12a, and in turn of system 100, relative to earth 10 and its orientation with respect to the celestial sphere. Each of the navigation sensors have a specific role to determine the i) orbital parameters of launch vehicle 12a, and in turn of system 100, relative to earth; ii) the orientation of launch vehicle 12a, and in turn of system 100, relative to earth and iii) the angular speed of launch vehicle 12a, and in turn of system 100, with respect to an inertial (celestial) frame centered at the earth. Each of the navigation sensors have a specific role to determine the i) orbital parameters of system 100 relative to earth; ii) the orientation and iii) the angular speed with respect to an inertial (celestial) frame centered at the Earth

A first sensor is one or more sun sensors 110 for determining the orientation of system 100 relative to the sun. A second sensor is a three-axis magnetometer 113 for determining the orientation and strength of the earth magnetic field of the earth at the sensor 113. The sun sensor and magnetometer measurements are used to determine the orientation of the launch vehicle with respect to an inertial reference frame with origin at the center of mass of the earth. A third sensor is an inertial measurement unit 112, which much like a gyroscope on a maritime ship, determines the angular rate of the launch vehicle 12a relative to a celestial reference frame with origin at the center of mass of earth. A fourth type of sensor is the Global Positioning System (GPS) receiver 114 which receives signals from the GPS satellite network orbiting earth 10 through the GPS antenna 118 to determine the position of launch vehicle 12a, and in turn sensor 106, relative to the earth. Lastly, a star tracker 116 may be used which determines the orientation of system 100 relative to known constellations.

It should be noted, that one or more of each of these types of sensors, or none of these types of sensors may be used. It is possible to utilize only a single such sensor, but to increase accuracy, so that in a preferred non limiting embodiment, the above enumerated sensors may be used in combination and in a preferred nonlimiting embodiment; at least one of each sensor is used in combination with all three of the other sensors in orbit determiner 108. Other such orbital and orientation determination sensors may be used in place of any of the above as is known in the art.

Command and data handling subsystem 104 receives the output of navigator108 through digital input/output module 120 and, utilizing an on board computer 119, determines the orbit parameters of system 100 relative to a center of mass 300 of the earth 10 (“earth frame”) and the orientation of the launch vehicle with respect to an inertial celestial frame with the origin at the center of mass of earth. Utilizing frame transformation processes, command and data handling subsystem 104 transforms the relative position and velocity vectors of the payload P relative to the launch vehicle 12a as determined by sensor 106, to the earth frame. The result is output to a ground station utilizing telecommunication subsystem 140 having a transceiver 144 and an antenna142. In a preferred non limiting embodiment system 100 broadcasts over the S-band. In another non limiting embodiment system 100 broadcasts results to a ground station or to payloads P themselves through a satellite communications system such as Globalstar or Iridium.

In a preferred nonlimiting embodiment, system 100 includes an electrical power subsystem 130. System 100 may be powered by onboard batteries 132 and/or solar panels 134. A power management and distribution subsystem 136 controls the output of energy from either batteries 132, solar panels 134 or both, to sensor 106, sensor 108 and command and data handling subsystem 104 in response to control signals from command and data handling subsystem 104. In this way, batteries 132 can be conserved as a function of the availability of solar power, and there is a backup power supply to prevent disruption of this functionality.

The operation of the electronic components is affected by temperature. As a result, system 100 includes a thermal control subsystem 122 having temperature sensors 124₁-124_{N} monitoring temperatures at various positions along system 100 and provide an input through analog-to-digital converter 122 commanding data handling subsystem 104. In a preferred nonlimiting embodiment the thermal control subsystem 122 operates passively and includes insulation 126 and one or more heat conduction components 128 to radiate heat away from the system components that require it. In yet another nonlimiting embodiment the thermal control subsystem includes active thermal control components such as heaters and coolers that are controlled either thermostatically, by a bimetal switch for example, or by the command and data handling subsystem 104.

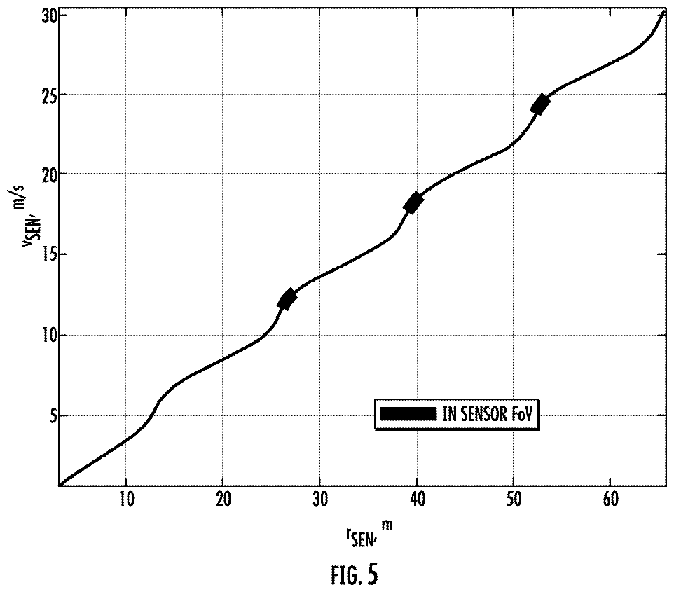

Reference is now made to FIGS. 4 and 5 in which a graphical representation of the operation of system 100 is provided. As discussed above, launch vehicle 12a can rotate as the payloads P are deployed. Sensors 106 which are fixed to the body of launch vehicle 12a rotate with launch vehicle 12a. Therefore as discussed above, payloads P may only appear within the field of view of a respective sensor 106 periodically. As shown in one extreme example in FIG. 4 sensor 106 is attached to launch vehicle 12a at a location away from the center of mass of the launch vehicle. Sensor 106 in this example has a field of view that extends 6°, full angle, in elevation and 36° in azimuth, full angle, relative to the boresight axis of the sensor. Because sensor 106 is rigidly attached to the launch vehicle 12a that rotates about its axis and the ejection force and environmental forces, such as drag, separate payload P_{N} from the launch vehicle, in this embodiment, a path indicated by the growth spiral extending from local ejection point (at time t₀) of launch vehicle 12a is the relative path of motion of the payload P_{N}, in the reference frame of sensor 106, as it reaches its own particular orbit O_{N}. In the embodiment shown, the relative path is that shown after 60 seconds from separation (at time t_{f}). The relative positions in which the payload P_{N} is captured within the field of view of sensor 106 are shown by the relatively thickened portions of the line C₁-C_{N}, and as expected increases as the payload P_{N} moves farther away from the initial ejection position.

Given the reflected signal received by the system 100 during each instance when the payload P_{N} is within the field of view of sensor 106, shown in FIG. 4, command and data handling subsystem 104 can operate on this information. In the nonlimiting embodiment shown in FIG. 4 sensor 106 determines the range (distance) and azimuth angle of payload P_{N} when the payload P_{N} is in the field of sensor 106 with a certain cadence. The set of range and azimuth angle pairs is used in an Unscented Kalman Filter (UKF) algorithm to determine the relative position and velocity vectors of payload P_{N} with respect sensor 106 reference frame. The command and data handling subsystem uses the (known before launch) position of sensor 106 in the reference frame of the launch vehicle 12a, the angular rate of the launch vehicle with respect to the celestial sphere determined with the gyroscope of the navigator, and the orbit of the launch vehicle with respect to earth, determined with the GPS receiver of the navigator, together with the relative position and velocity vector of the payload P_{N} to calculate the orbit of payload P_{N} with respect to earth.

In one nonlimiting embodiment sensor 106 measures range (distance), azimuth, and elevation. In yet another nonlimiting embodiment sensor 106 only measures range.

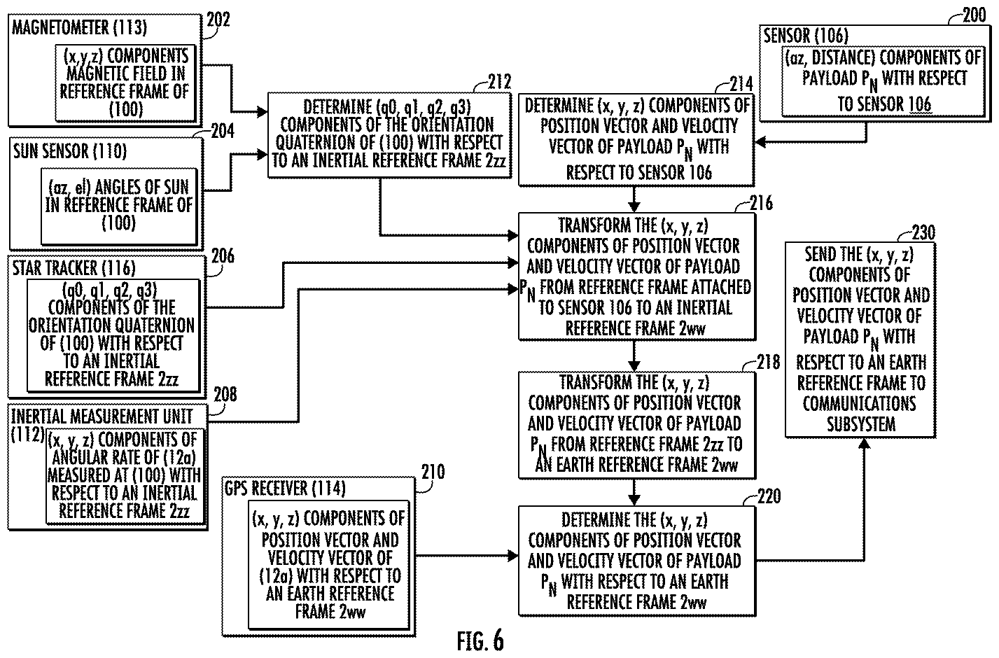

Reference is now made to FIG. 6 in which the method of operation of initial orbit determination system 100 is shown. In a step 200, sensor 106 determines information about a sensed payload P_{N}. Sensor 106 is continuously outputting sensor data in step 200. Sensor 106 outputs data is indicative of either i) range (distance); ii) range or azimuth; and iii) range, azimuth and elevation of P_{N} relative to the sensor and in turn the platform.

At the same time, navigation subsystem 108 is continuously receiving, from a plurality of sensors, data that is used in the initial orbit determination of the payload P_{N} that is in the field of view of the sensor. In a step 202 navigation subsystem 108 utilizes magnetometer measurements input from magnetometer 113 to determine the orientation of the platform 100 with respect to an inertial reference frame with origin at the center of mass of the earth 10. In a step 204 the attitude (azimuth , elevation) of launch platform 100 is determined with respect to the celestial sphere by utilizing star tracker 116 or sun sensor 110. In a step 206 star tracker 116 determines components of the orientation of the quaternion with respect to an inertial reference frame . Simultaneously, in a step 208 navigation subsystem 108, utilizing inertial measurement unit 112 determines the (x,y,z) components of angular rate of launch vehicle 12a measured at the platform 100 with respect to an inertial reference frame. utilizing the output of the onboard gyroscope of inertial measurement unit 112. Additionally, platform position and velocity with respect to earth 10 are determined in a step 210 either by GPS receiver 114 or by command and data handling subsystem 104 utilizing other inputs.

In a step 212, command and data handling subsystem 104 receives the outputs of magnetometer 113 and sun sensor 110 and determines the components of the orientation quaternion with respect to an inertial reference frame. Simultaneously, in a step 214 command and data handling subsystem 104 estimates the position and velocity of payload P_{N} relative to at least one sensor 106.

In a step 216, command and data handling subsystem 104 receives the output of star tracker 116 and inertial measurement unit, 112 determined in step 208, utilizes the determined components of position vector and velocity vector of the payload P_{N} and the determined components of the orientation quaternion as determined in step 212 and 214 and transforms the (x,y,z) components of the position vector and velocity vector of payload P_{N} from the sensor 106 reference frame to an inertial reference frame 2zz. In a step 218, command and data handling subsystem 104 utilizes this transformed inertial reference frame to transform the (x,y,z) components of the position vector and velocity vector of payload P_{N} from the inertial reference frame 2zz to an earth reference frame 2ww.

Command and data handling subsystem 104, in response to the determined transformed inertial reference frame from step 218, determines the position and velocity of payload P_{N} relative to earth 10 in a step 220. Then in a step 230, the position of payload P_{N} and velocity relative to earth is transmitted to earth utilizing telecommunication subsystem 140.

Once system 100 determines an initial orbit of payload P_{N} and communication subsystem 140 establishes a link the initial orbit of payload P_{N} is transmitted. In a nonlimiting embodiment communication subsystem 140 transmits the initial orbit data to a ground station directly. In another nonlimiting embodiment communication subsystem 140 transmits the initial orbit to the ground station through a satellite communication system such as Globalstar or Iridium.

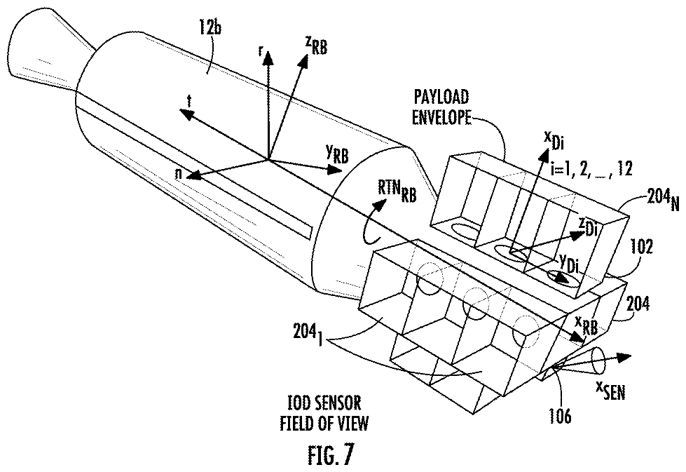

Reference is now made to FIG. 7 in which system 100 is deployed on a launch vehicle 12b; like numerals are used for like structure for ease of explanation, the primary difference being the orientation of sensor 106 relative to deployers 204. The field of view of sensor 106 is substantially orthogonal to the direction of deployment of payloads P. In this situation sensor 106 is provided with wide field of view to capture payloads as they leave launch vehicle 12b.

With the above invention, determination of the initial orbit of payloads, space objects, is achievable soon, tens of seconds to minutes, after their deployment from a launch vehicle is achievable. Furthermore, while the above example is provided in connection with initial orbit determination of satellites launched from a launch vehicle, the system can also determine the density of atmosphere, between the launch vehicle and the payload space objects, after deployment. Furthermore, as can be seen above, it can determine both the motion of spacecraft fragments (debris) that result either from impact with an external object or from a spacecraft-internal event that generates debris; including the determination of the direction, size, and speed of the impacting object. Because of this the method and system are easily adaptable to determine the possibility of collision with an object upon which the system resides with another space object.

In another nonlimiting embodiment, the active sensor uses the transmit signal to broadcast the initial orbit data to the payload P_{N} that is equipped with a receiver and command and data handling subsystem capable of receiving and interpreting the data.

In other nonlimiting embodiments sensor 106 can have its own microcontroller. The user can set various parameters such as measurement cadence, intensity of the emitted laser beam, etc. through the command and data handling subsystem 104. The user can also read housekeeping data such as voltages and temperatures that can be transmitted to earth and used for improvements of the design.

Additionally, components of the navigation subsystem 108 such as the star trackers, GPS receiver, and Inertial Measurement Unit (IMU) may have their own microcontrollers as well that interface with the command and data handling subsystem 104 with a two-way interface. The user can set update rates, and read housekeeping data such as voltages and temperatures.

Because sensor 106 is near the payloads P (on board within meters or less, not earthbound) sensor 106 can be small and use little electric power. Sensor 106 is not overwhelmed by the multitudes of the payloads deployed because only a few payloads P will be in its field of view at the same time. Again, this is due to the proximity to the payloads P of sensor 106. To gather all the data needed for initial orbit determination the system 100 has components commonly used in satellites. However, in the inventive system they are configured to perform initial orbit determination instead of the functions of a satellite.

While this invention has been particularly shown and described to reference the preferred embodiments thereof, it would be understood by those skilled in the art that various changes in form and detail may be made therein without departing from the scope of the invention encompassed by the appended claims.

1. A system for determining an initial orbit of an object launched from an orbiting launch vehicle comprising:
a sensor affixed to the launch vehicle; the sensor transmits electromagnetic signals toward the object launched from the launch vehicle, and receives signals reflected therefrom as reflected signals;
a navigation subsystem determining a relative position of the sensor to the earth; and
a command and data handling subsystem receiving the reflected signals and the relative position as determined by the navigation subsystem and determining a relative position of the object launched from the launch vehicle relative to earth.

2. The system for determining an initial orbit of claim 1, wherein the sensor transmits the electromagnetic signals in a direction substantially parallel to the direction of launch of the object launched from the launch vehicle.

3. The system for determining an initial orbit of claim 1, wherein the sensor has a field of view, the field of view having a width, the width of the field of view being greater than or equal to a depth of the field of view.

4. The system for determining an initial orbit of claim 1, wherein the sensor is one of LIDAR and RADAR.

5. The system for determining an initial orbit of claim 1, further comprising at least a second sensor affixed to the launch vehicle; the at least second sensor transmits electromagnetic signals toward the object launched from the launch vehicle, and receives signals reflected therefrom as reflected signals and the navigation subsystem determining a relative position of the at least second sensor to the earth.

6. The system for determining an initial orbit of claim 1, wherein the command and data handling subsystem determines the relative position of at least one object launched from the launch vehicle to the launch vehicle.

7. The system for determining an initial orbit of claim 1, wherein the navigation subsystem includes a magnetometer for determining the orientation of the launch vehicle with respect to an inertial reference frame.

8. The system for determining an initial orbit of claim 1, wherein the navigation subsystem includes a sun sensor for determining the angle of launch vehicle relative to the sun.

9. The system for determining an initial orbit of claim 1, wherein the navigation subsystem includes a star tracker for determining the position of launch vehicle relative to at least one known star.

10. The system for determining an initial orbit of claim 1, wherein the navigation subsystem includes an inertial measurement unit for determining the angular rate of the launch vehicle relative to an inertial reference frame.

11. The system for determining an initial orbit of claim 1, wherein the navigation subsystem includes a GPS.

12. The system for determining an initial orbit of claim 1, wherein the navigation subsystem includes a magnetometer for determining the orientation of the launch vehicle with respect to an inertial reference frame, a sun sensor for determining the angle of launch vehicle relative to the sun, a star tracker for determining the position of launch vehicle relative to at least one known star, and an inertial measurement unit for determining the angular rate of the launch vehicle relative to an inertial reference frame:
the command and data handling subsystem determines the x,y,z components of a position vector and a velocity vector of the object launched from the vehicle relative to the sensor as a function of the received reflected signals; and
the command and data handling subsystem transforming the x,y,z components of the position vector and the velocity vector of the object launched form the vehicle from a reference frame relative to attached sensor to an earth reference frame, as a function of the position vector and the velocity vector of the object launched form the vehicle, and at least one of i.) the orientation of the launch vehicle with respect to an inertial reference frame, ii.) the angle of launch vehicle relative to the sun, iii.) the position of launch vehicle relative to at least one known star, and iv.) the angular rate of the launch vehicle relative to an inertial reference frame.

13. A method for determining an initial orbit of an object launched from an orbiting launch vehicle, the orbiting launch vehicle having at least one sensor affixed thereto, a navigation subsystem thereon, and a command and data handling subsystem operatively coupled to the at least one sensor and navigation subsystem, the method comprising the steps of:
transmitting electromagnetic signals from the alt least one sensor toward the object launched from the launch vehicle, and receiving signals reflected therefrom at the sensor as reflected signals;
determining a relative position of the sensor as a function of the of the reflected signals to the earth utilizing the navigation subsystem; and
receiving the reflected signals and the relative position as determined by the navigation subsystem at the command and data handling subsystem and determining a relative position of the object launched from the launch vehicle relative to earth.

14. The method of claim 13, further comprising the step of transmitting the electromagnetic signals in a direction substantially parallel to the direction of launch of the object launched from the launch vehicle.

15. The method of claim 13, further comprising the steps of;
determining the orientation of the launch vehicle relative to an inertial reference frame:
determining the x,y,z components of a position vector and a velocity vector of the object launched from the vehicle relative to the sensor as a function of the received reflected signals; and
transforming the x,y,z components of the position vector and the velocity vector of the object launched form the vehicle from a reference frame relative to the attached sensor to an earth reference frame, as a function of the position vector and the velocity vector of the object launched form the vehicle, and at least one of i.) an orientation of the launch vehicle with respect to an inertial reference frame, ii.) an angle of launch vehicle relative to the sun, iii.) a position of launch vehicle relative to at least one known star, and iv.) an angular rate of the launch vehicle relative to an inertial reference frame.

16. The method of claim 13, wherein the launch vehicle has at least a second sensor attached thereto; and the method further comprising the steps of :
transmitting electromagnetic signals from the alt least second sensor toward the object launched from the launch vehicle, and receiving signals reflected therefrom at the at least second sensor as reflected signals;
determining a relative position of the at least second sensor to the earth, utilizing the navigation subsystem, as a function of the of the reflected signals from the at least first sensor and at least second sensor; and
receiving the reflected signals form the at least first sensor and at least second sensor and the relative position as determined by the navigation subsystem at the command and data handling subsystem and determining a relative position of the object launched from the launch vehicle relative to earth.
